(19) United States
(12) Patent Application Publication
(10) Pub. No.: US 2019/0251761 A1
(43) Pub. Date: Aug. 15, 2019

(54) INFORMATION COLLECTION METHOD AND INFORMATION COLLECTION DEVICE

(71) Applicant: Panasonic Intellectual Property Management Co., Ltd., Osaka (JP)

(72) Inventors: ETSUJI SATOU, Tokyo (JP); HIROKI KAWAHARA, Kanagawa (JP); NORIHIKO KOBAYASHI, Tokyo (JP)

(21) Appl. No.: 16/344,838

(22) PCT Filed: Oct. 26, 2017
(86) PCT No.: PCT/JP2017/038618

§ 371 Date: Apr. 25, 2019

(30) Foreign Application Priority Data
Nov. 16, 2016 (JP) 2016-223294

(51) Int. Cl. G07C 5/00; G07C 5/08; H04W 4/44; H04W 4/029; H04M 11/00

(52) U.S. Cl. CPC G07C 5/008; G07C 5/0841; H04M 11/00; H04W 4/029; H04W 4/44

(57) ABSTRACT

Provided is an information collection method in an information collection apparatus that communicates with at least a first information provision apparatus and a second information provision apparatus via a network. The information collection method includes transmitting, when the information collection apparatus has received first information associated with an incident from the first information provision apparatus, second information corresponding to the first information to at least the second information provision apparatus. Further, the information collection method includes receiving by the information collection apparatus third information associated with the incident from the second information provision apparatus having received the second information.

### TECHNICAL FIELD

The present disclosure relates to an information collection method and an information collection apparatus that can collect information about incidents.

### BACKGROUND ART

As such a type of information collection apparatus, there is a conventional computer for collecting information described in PTL 1, for example. Specifically, if one vehicle has caused an accident, image information of a drive recorder mounted on the vehicle is fixed, and an on-vehicle device of the accident vehicle collects image information of drive recorders in another vehicle and a fixed apparatus around there and stores the image information. The information collected by the on-vehicle device of the accident vehicle is received by a computer for collecting information through a communication network.

### CITATION LIST

### Patent Literature

PTL 1: Japanese Patent Unexamined Publication No. 2009-20774

### SUMMARY OF THE INVENTION

The present disclosure provides further improvement of an information collection method and an information collection apparatus.

An aspect of the present disclosure is directed to an information collection method in an information collection apparatus capable of communication with at least a first information provision apparatus and a second information provision apparatus via a network. The information collection method includes transmitting, when the information collection apparatus has received first information associated with an incident from the first information provision apparatus, second information corresponding to the first information to at least the second information provision apparatus. Further, the information collection method includes receiving by the information collection apparatus third information associated with the incident from the second information provision apparatus having received the second information.

Another aspect of the present disclosure is directed to an information collection apparatus capable of communication with at least a first information provision apparatus and a second information provision apparatus via a network. When the information collection apparatus has received first information associated with an incident from the first information provision apparatus, the information collection apparatus transmits second information corresponding to the first information to at least the second information provision apparatus. Further, the information collection apparatus receives third information associated with the incident from the second information provision apparatus having received the second information.

Note that modifications of aspects of the present disclosure that are modified between methods, apparatuses, systems, recording media (including computer-readable non-transient recording media), computer programs, or the like are also effective as the aspects of the present disclosure.

With the present disclosure, it is possible to provide an improved information collection method and an information collection apparatus, more specifically, an information collection method and an information collection apparatus that can collect more information.

### BRIEF DESCRIPTION OF DRAWINGS

FIG. 1 is a diagram showing an overall configuration of an information collection system having an information collection apparatus according to an exemplary embodiment of the present disclosure.

FIG. 2A is a diagram showing a detailed configuration of an on-vehicle terminal device of FIG. 1.

FIG. 2B is a diagram showing a detailed configuration of a first fixed apparatus of FIG. 1.

FIG. 2C is a diagram showing a detailed configuration of a second fixed apparatus of FIG. 1.

FIG. 2D is a diagram showing a detailed configuration of a mobile terminal apparatus of FIG. 1.

FIG. 2E is a diagram showing a detailed configuration of the information collection apparatus of FIG. 1.

FIG. 3A is a flowchart showing a process procedure of the on-vehicle terminal device of FIG. 1.

FIG. 3B is a flowchart showing a process procedure of the first fixed apparatus of FIG. 1.

FIG. 3C is a flowchart showing a process procedure of the second fixed apparatus of FIG. 1.

FIG. 3D is a flowchart showing a process procedure of the mobile terminal apparatus of FIG. 1.

FIG. 3E is a flowchart showing a process procedure of the information collection apparatus of FIG. 1.

FIG. 4A is a diagram showing time series information generated on the information collection apparatus of FIG. 1.

FIG. 4B is a diagram showing map information generated on the information collection apparatus of FIG. 1.

FIG. 5 is a diagram showing a front half of a sequence on the information collection system of FIG. 1.

### DESCRIPTION OF EMBODIMENT

Hereinafter, an information collection method and an information collection apparatus of the present disclosure will be described in detail with reference to the drawings.

### 1. Definitions

Table 1 below shows meanings of acronyms and the like used in the present exemplary embodiment.

TABLE 1
Meaning of acronyms and the like

| Acronyms and the like | Meaning |
|---|---|
| ITS | Intelligent Transport Systems |
| GPS | Global Positioning Systems |
| ID | Identifier |

<2. Basic Configuration of Information Collection System>

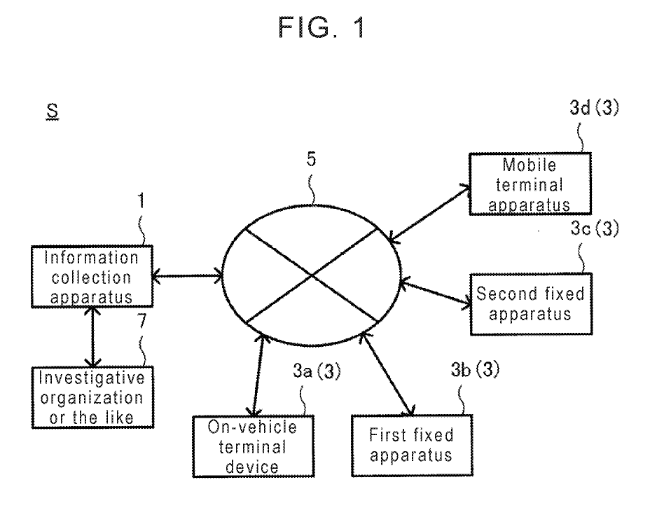

With respect to FIG. 1, information collection apparatus 1 and a plurality of information provision apparatuses 3 are connected to information collection system S via communication network 5 to be capable of data communication. On-vehicle terminal device 3a, first fixed apparatus 3b, second fixed apparatus 3c, and mobile terminal apparatus 3d are examples of the plurality of information provision apparatuses 3.

Note that to communication network 5 there are typically connected a plurality of on-vehicle terminal devices 3a, a plurality of first fixed apparatuses 3b, a plurality of second fixed apparatuses 3c, and a plurality of mobile terminal apparatuses 3d. However, FIG. 1 shows, for convenience, a configuration in which each one of on-vehicle terminal device 3a, first fixed apparatus 3b, second fixed apparatus 3c and mobile terminal apparatus 3d is connected to communication network 5.

First, each of information provision apparatuses 3 will be described.

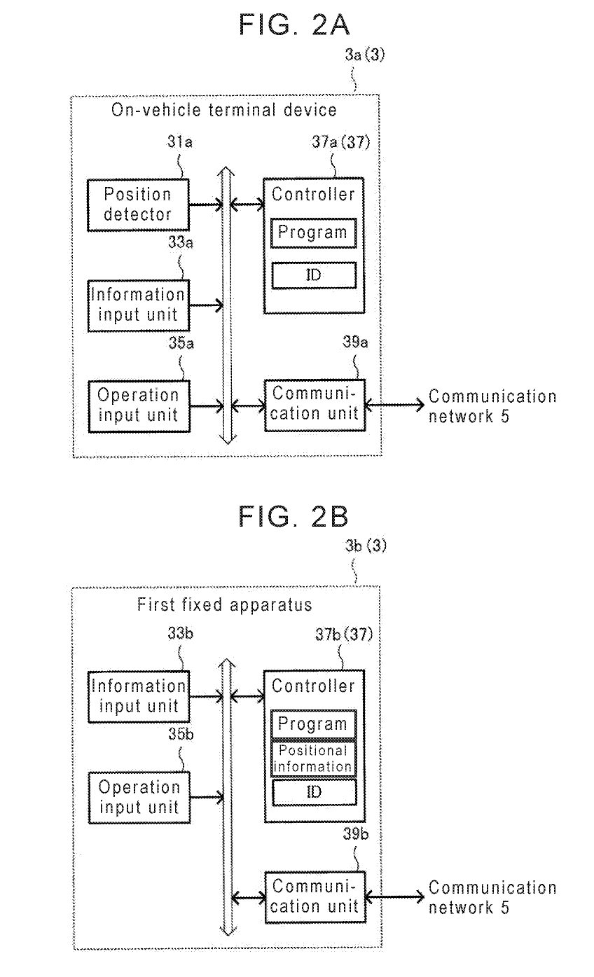

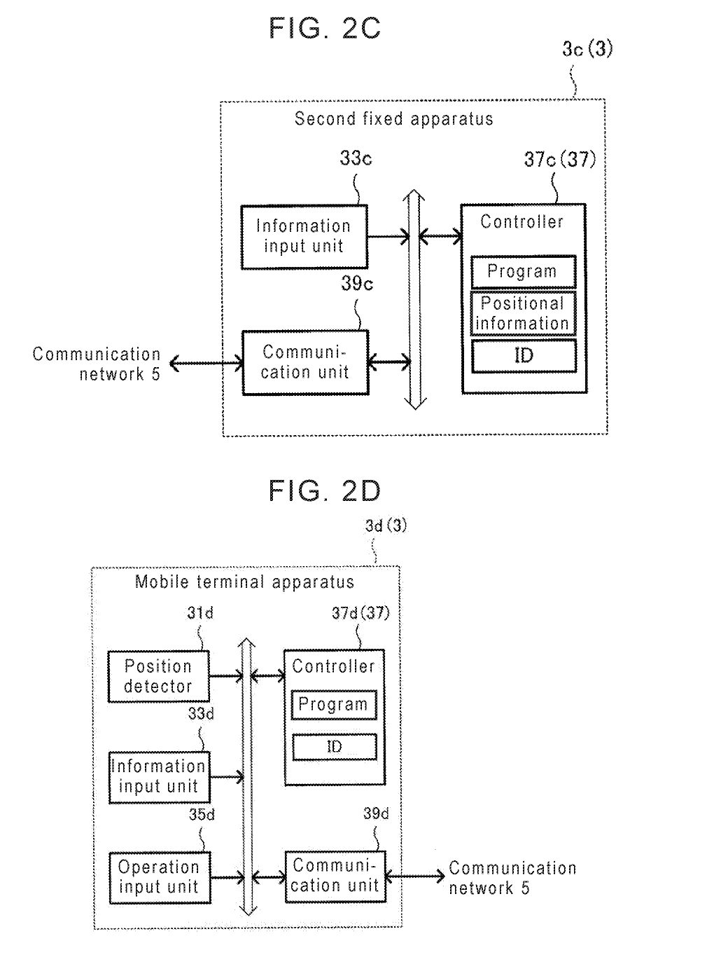

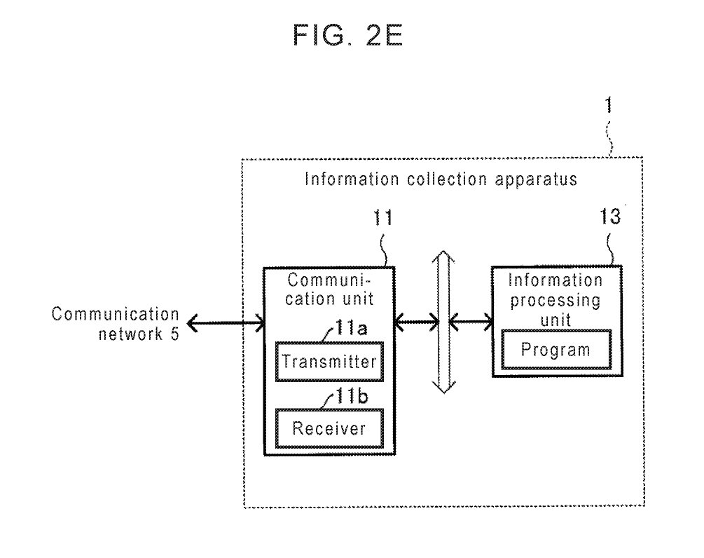

First, on-vehicle terminal device 3a is installed in a vehicle and has, as shown in FIG. 2A, position detector 31a, information input unit 33a, operation input unit 35a, controller 37a, and communication unit 39a.

Position detector 31a is, for example, a GPS receiver, which obtains a current position of on-vehicle terminal device 3a by calculation or other methods and outputs the current position to controller 37a.

Information input unit 33a is typically an in-vehicle camera, which generates movie information of an appearance around the vehicle (for example, in front) and sends the movie information to controller 37a.

Operation input unit 35a is realized by, for example, a graphic button displayed on a touch screen (not shown) or a physical button provided on on-vehicle terminal device 3a. When operation input unit 35a is operated, operation input unit 35a generates a signal indicating that operation input unit 35a is operated, and outputs the signal to controller 37a.

Controller 37a includes a microprocessor that executes a program downloaded in an internal memory. Although the process in controller 37a will be described later in detail, an outline of the process is as items (1), (2) below.

(1) Holding movie information that is acquired from information input unit 33a and corresponds to a time range between a current time and a time point that is a predetermined time backward from the current time (drive recorder function).

(2) In response to receiving tag information or an operation, of a person on board (including a fellow passenger), on operation input unit 35a, transmitting movie information held at that point in time from communication unit 39a to information collection apparatus 1.

Communication unit 39a outputs to controller 37a various types of information received from information collection apparatus 1 via communication network 5. Other than the above information, communication unit 39a sends out to communication network 5 various types of information to be transmitted to information collection apparatus 1.

First fixed apparatus 3b is, for example, a personal computer (hereinafter, referred to as PC) or the like installed in a building (shop, house, facility, or the like) along a road and has information input unit 33b, operation input unit 35b, controller 37b, and communication unit 39b as shown in FIG. 2B.

Information input unit 33b is typically a surveillance camera and a security camera, generates movie information showing an appearance around a building where information input unit 33b is installed, and outputs the movie information to controller 37b.

Alternatively, information input unit 33b may be a keyboard (not shown) equipped on first fixed apparatus 3b. In this case, the keyboard may be a physical keyboard equipped on first fixed apparatus 3b or a screen keyboard capable of being displayed on a touch screen (not shown) equipped on first fixed apparatus 3b. A user operates these keyboards to input characters. In the present disclosure, an input character string is typically a short sentence about an incident. Information input unit 33b generates character information representing such a short sentence and outputs the character information to controller 37b.

Operation input unit 35b is realized by, for example, a graphic button displayed on a touch screen (not shown) or a physical button provided on first fixed apparatus 3b. When operation input unit 35b is operated, operation input unit 35b generates an electric signal indicating that operation input unit 35b is operated, and outputs the electric signal to controller 37b.

Controller 37b includes a memory and a microprocessor.

Memory stores positional information indicating a place where first fixed apparatus 3b is installed. The positional information is typically a longitude and latitude of a representative position of a place where the building is located. The positional information may include address information besides the information of longitude and latitude. Alternatively, the positional information may be address information.

The microprocessor executes a program downloaded in the memory. Although the process in the microprocessor will be described later in detail, an outline of the process is as items (1), (2) below

(1) Holding movie information that is acquired from information input unit 33b and corresponds to a time range between a current time and a time point that is a predetermined time backward from the current time.

(2) In response to receiving tag information or an operation of a user on operation input unit 35b, transmitting movie information and character information acquired from information input unit 33b from communication unit 39b to information collection apparatus 1.

Since first fixed apparatus 3b can have an auxiliary storage device (not shown) having a larger capacity than the memory on on-vehicle terminal device 3a, it is possible to hold movie information for a long period of time.

Because communication unit 39b is similar to above-described communication unit 39a, a detailed description of communication unit 39b is skipped.

Second fixed apparatus 3c is, for example, an ITS spot installed along a road or other devices and basically has information input unit 33c, controller 37c, and communication unit 39c as shown in FIG. 2C.

Because information input unit 33c, controller 37c, and communication unit 39c are respectively similar to above-described information input unit 33b, controller 37b, and communication unit 39b, respective detailed descriptions are skipped.

Mobile terminal apparatus 3d is, for example, a mobile phone, a smartphone, or other devices carried by a user and has position detector 31d, information input unit 33d, operation input unit 35d, controller 37d, and communication unit 39d as shown in FIG. 2D.

Because position detector 31d is similar to above-described position detector 31a, a detailed description of position detector 31d is skipped.

Information input unit 33d is typically a camera mounted on a mobile terminal apparatus, generates movie information and still image information each showing an appearance around information input unit 33d, and outputs the movie information and the still image information to controller 37d.

Alternatively, information input unit 33d may be a keyboard similar to above-described information input unit 33b. A user enters, for example, a short sentence about an incident by operating these keyboards. Information input unit 33d generates character information representing such a short sentence and outputs the character information to controller 37d.

Operation input unit 35d is, for example, a microphone, converts an input voice of a user into an electric signal or the like and outputs the electric signal to controller 37d. Operation input unit 35d may be a graphic button displayed on a display (not shown) or may be a physical button provided on mobile terminal apparatus 3d. In the case of these buttons, when each button is operated by a user, operation input unit 35d generates an electric signal indicating that the button is operated by the user, and outputs the electric signal to controller 37d.

Because controller 37d and communication unit 39d are respectively similar to above-described controller 37a and communication unit 39a, and respective detailed descriptions are skipped.

Information collection apparatus 1 is installed remotely from on-vehicle terminal device 3a, first fixed apparatus 3b, second fixed apparatus 3c, and mobile terminal apparatus 3d and performs data communication with these on-vehicle terminal device 3a, first fixed apparatus 3b, second fixed apparatus 3c, and mobile terminal apparatus 3d via communication network 5. Information collection apparatus 1 has communication unit 11 and information processing unit 13 as shown in FIG. 2E. Communication unit 11 has transmitter 11a and receiver 11b.

Receiver 11b of communication unit 11 receives information from each of on-vehicle terminal device 3a, first fixed apparatus 3b, second fixed apparatus 3c, and mobile terminal apparatus 3d via communication network 5 and outputs the information to information processing unit 13. Transmitter 11a of communication unit 11 sends out to communication network 5 information to be sent to each of on-vehicle terminal device 3a, first fixed apparatus 3b, second fixed apparatus 3c, and mobile terminal apparatus 3d.

Information processing unit 13 includes a microprocessor that executes a program previously stored in an internal memory. A process in information processing unit 13 will be described later in detail.

Refer to FIG. 1 again. Communication network 5 is typically a combination of the internet and a wire-less communication network.

### 3. Participation in Information Collection System

A summary of a main feature of information collection apparatus 1 is as follows. In information collection apparatus 1, information processing unit 13 first receives, from information provision apparatus 3 in the surrounding area of a spot where some incident (instance such as a traffic accident) has occurred, information (hereinafter, referred to as initial information) informing of the occurrence of the incident via communication network 5 and receiver 11b of communication unit 11. Information processing unit 13 next generates tag information to be used for at least associating of the incident. Next, information processing unit 13 sends out the generated tag information to communication network 5 via transmitter 11a of communication unit 11. Next, receiver 11b of communication unit 11 receives additional information related to the incident (hereinafter, the referred to as additional information) from information provision apparatus or apparatuses 3 that have responded to reception of the tag information, and receiver 11b of communication unit 11 outputs the additional information to information processing unit 13.

The initial information corresponds to first positional information or first information of the present disclosure. The tag information corresponds to second positional information or second information of the present disclosure. The additional information corresponds to third positional information or third information of the present disclosure.

Each of the initial information and additional information includes, for example, a terminal ID, time information, positional information, information type information, terminal type information, incident-and-accident related information, and other information. The time information is, for example, information of transmission time of initial information or additional information. The positional information is, for example, longitude and latitude information, address information, and other information. The incident-and-accident related information is, for example, image information, movie information, voice information, character information, URL information, and other information. The URL information is information of a URL indicating where image information, movie information, or voice information is. Each of the initial information and the additional information has at least one piece of the above information.

The tag information includes, for example, time information such as a transmission time of initial information or additional information, positional information; information type information, terminal type information, incident-and-accident related information, and other information. The positional information is, for example, longitude and latitude information, address information, and other information. The incident-and-accident related information is, for example, image information, movie information, voice information, character information, URL information, and other information. The tag information includes at least one piece of the above information.

For collecting such information, after a program for providing information is installed in each of on-vehicle terminal device 3a, first fixed apparatus 3b, second fixed apparatus 3c, and mobile terminal apparatus 3d, various settings are configured, and a unique ID to be used when information is provided to information collection apparatus 1 is assigned to each of these apparatuses. The assigned ID is stored in the memory equipped in controller 37 (more specifically, controller 37a, controller 37b, controller 37c, and controller 37d) of each information provision apparatus 3.

### 4. Process and Operation of Each Component of Information Collection System

Hereinafter, a description will be given on a process and operation of on-vehicle terminal device 3a, first fixed apparatus 3b, second fixed apparatus 3c, mobile terminal apparatus 3d, and information collection apparatus 1 of information collection system S.

<4-1. About On-Vehicle Terminal Device>

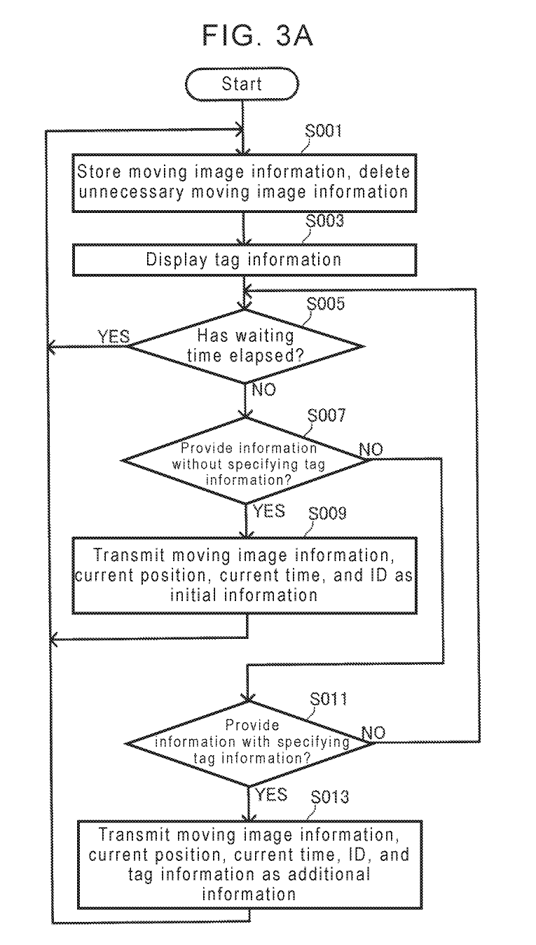

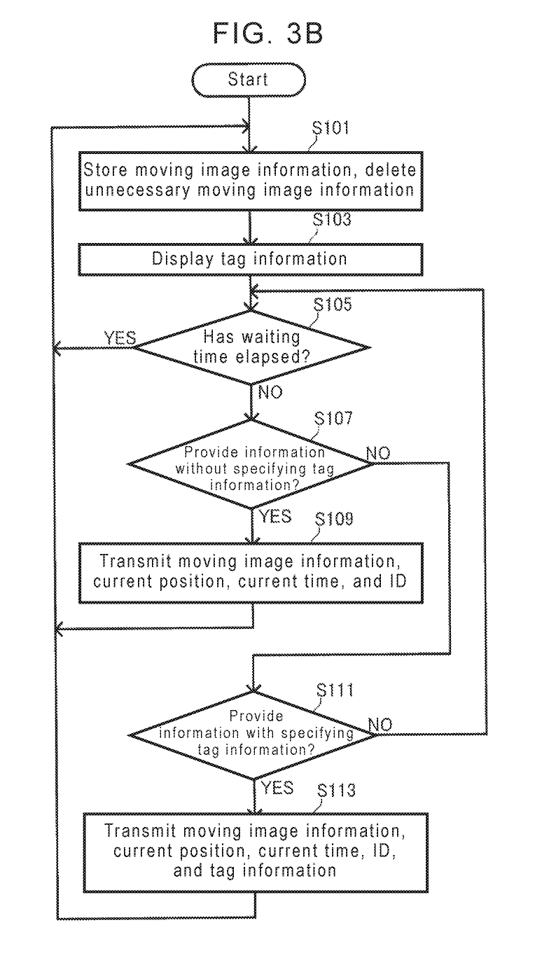

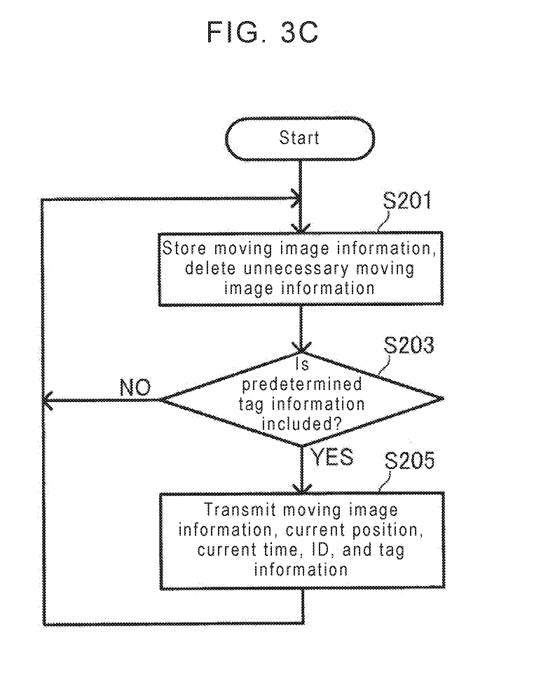

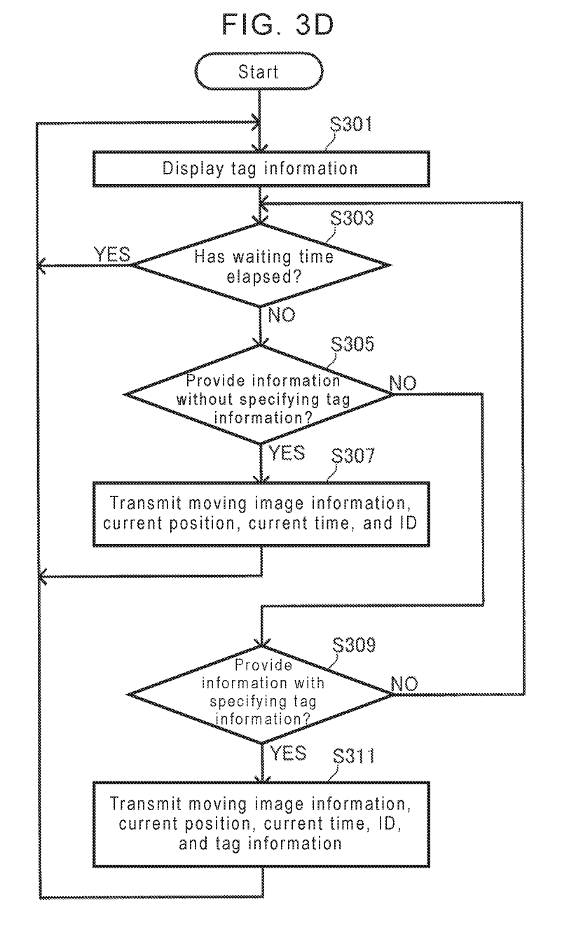

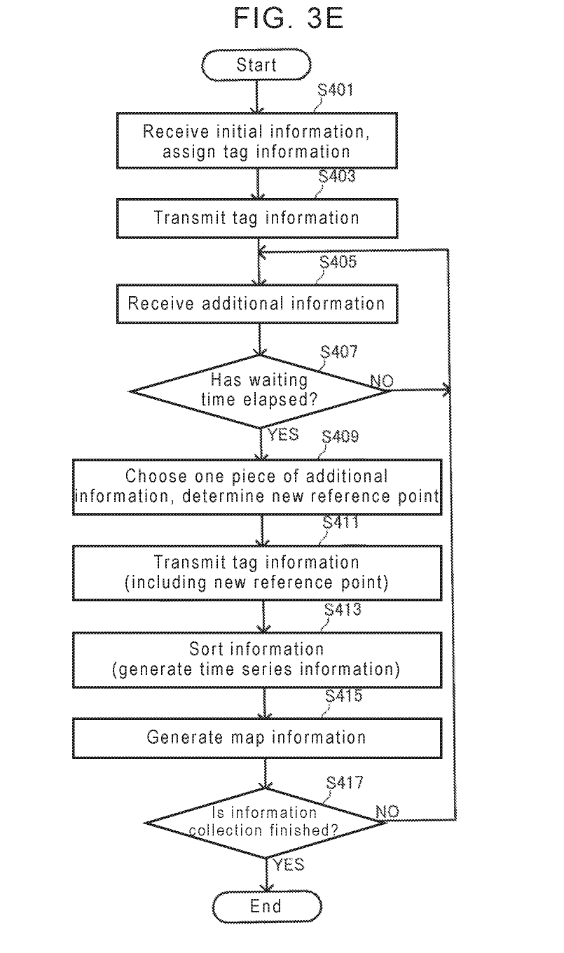

As shown by step S001 of FIG. 3A, after start-up of on-vehicle terminal device 3a, controller 37a functions as a drive recorder, stores movie information acquired from information input unit 33a in the memory, and deletes, from the memory, movie information beyond a time point that is a predetermined time backward from a current time.

Next, in step S003 of FIG. 3A, controller 37a chooses predetermined tag information from tag information delivered from information provision apparatus or apparatuses 3 and displays a list of the predetermined tag information on a screen (not shown). Hereinafter, a process in step S003 will be described in detail.

As a preferable example, the tag information includes an address of an incident occurrence point and positional information of a reference point in a geographical range within which information is requested in relation to an object incident. In other words, at least the tag information includes positional information as the reference point corresponding to the positional information in the initial information. The positional information is, for example, longitude and latitude information, address information, and other information. The reference point is initially a spot where the object incident occurred, but the reference point can change with lapse of time.

Controller 37a acquires a current position of on-vehicle terminal device 3a from position detector 31a and chooses predetermined tag information. The predetermined tag information includes a reference point whose spatial distance to the current position of on-vehicle terminal device 3a is smaller than a predetermined distance (for example, 300 m). In other words, the predetermined tag information defines an area that includes the spot corresponding to the positional information in the initial information and is wider than the positional information in the initial information.

After step S003, in a case where a person on board watched an incident and an address of the spot where the incident occurred is in the displayed list, if the person on board wants to transmit additional information to information provision apparatuses 3, the person on board specifies tag information being displayed by using operation input unit 35a and enters, with respect to operation input unit 35a, his or her intention that the person on board will provide information.

On the other hand, in a case where the person on board watched an incident and wants to transmit initial information without specifying tag information to information provision apparatus 3, the person on board enters, with respect to operation input unit 35a, his or her intension only to transmit initial information to information provision apparatuses 3.

Next to step S003, controller 37a determines in step S005 of FIG. 3A whether a predetermined waiting time has elapsed since the execution of step S003 or not.

In response to the determination, if the determination is NO in step S005, controller 37a determines in step S007 of FIG. 3A whether to provide information without specifying tag information or not.

If the determination is YES in step S007, controller 37a sends out currently held movie information as the initial information together with a current position acquired from position detector 31a, a current time acquired from a timer (not shown), and the ID of on-vehicle terminal device 3a to communication network 5 via communication unit 39a as shown in step S009 of FIG. 3A.

In contrast to the above, if the determination is NO in step S007, controller 37a determines whether to provide information with specifying tag information or not in step S011 of FIG. 3A.

If the determination is YES in step S011, controller 37a sends out currently held movie information as the additional information together with the current position and the ID of on-vehicle terminal device 3a, the current time, and the specified tag information to communication network 5 via communication unit 39a as shown in step S013 of FIG. 3A.

In contrast to the above, if the determination is NO in step S011, controller 37a goes back to step S005.

Further, if the determination is YES in step S005 or after steps S009, S013 are executed, controller 37a goes back to step S001.

<4-2. About First Fixed Apparatus>

A process and operation of first fixed apparatus 3b are similar to the process and operation of on-vehicle terminal device 3a. Therefore, the process and operation of first fixed apparatus 3b will be described simply.

In first fixed apparatus 3b, when a program has started up, controller 37b stores movie information acquired from information input unit 33b in an internal memory or an auxiliary storage device and deletes movie information that has become unnecessary, as shown in step S101 of FIG. 3B.

Next, in step S103 of FIG. 3B, controller 37b chooses predetermined tag information delivered from information provision apparatus or apparatuses 3 and displays a list of the predetermined tag information on a screen (not shown). The predetermined tag information is similar to the above description and is not described in detail.

Next to step S103, in step S105 of FIG. 3B, if controller 37b determines that a predetermined waiting time has not elapsed since the execution of step S103, controller 37b determines whether to provide information without specifying tag information or not in step S107 of FIG. 3B.

If the determination is YES in step S107, controller 37b sends out currently held movie information together with an installation position of first fixed apparatus 3b stored in the internal memory, a current time acquired from a timer (not shown), and the ID of first fixed apparatus 3b to communication network 5 via communication unit 39b as shown in step S109 of FIG. 3B.

In contrast to the above, if the determination is NO in step S107, controller 37b determines whether to provide information with specifying the tag information or not in step S111 of FIG. 3B.

If the determination is YES in step S111, controller 37b sends out the specified tag information together with currently held movie information, the installation position and the ID of first fixed apparatus 3b, and the current time to communication network 5 via communication unit 39b as shown in step S113 of FIG. 3B.

In contrast to the above, if the determination is NO in step S111, controller 37b executes step S105.

Further, if the determination is YES in step S105 or after steps S109, S113 are executed, controller 37b goes back to step S101.

<4-3. About Second Fixed Apparatus>

A process and operation of second fixed apparatus 3c are partially similar to the process and operation of first fixed apparatus 3b as shown in FIG. 3C. Therefore, the process and operation of second fixed apparatus 3c will be described simply.

In second fixed apparatus 3c, controller 37c stores still image information or the like acquired from information input unit 33c in an internal memory or an auxiliary storage device and deletes still image information and the like that have become unnecessary, as shown in step S201 of FIG. 3C. Note that as described above, second fixed apparatus 3c is an ITS spot, for example. In this case, second fixed apparatus 3c receives still image information and the ID of on-vehicle terminal device 3a mainly from on-vehicle terminal device 3a. However, other than the above, second fixed apparatus 3c can further receive movie information.

Next, as shown in step S203 of FIG. 3C, controller 37c determines whether the tag information delivered from information provision apparatus or apparatuses 3 includes the predetermined tag information (described above) or not.

If the determination is NO in step S203, controller 37c goes back to above-described step S201. If the determination is YES in step S203, controller 37c sends out movie information for a predetermined past time period together with the tag information found in step S203, an installation position and the ID of second fixed apparatus 3c, and a current time to communication network 5 via communication unit 39c as shown in step S205 of FIG. 3C.

Controller 37c goes back to step S201 when step S205 of FIG. 3C is finished.

<4-4. About Mobile Terminal Apparatus>

When a program has started up in mobile terminal apparatus 3d, controller 37d chooses the predetermined tag information (described above) delivered from information provision apparatus or apparatuses 3 and display a list of the tag predetermined information on a screen (not shown) as shown in step S301 of FIG. 3D. The predetermined tag information is similar to the above description and is not described in detail.

After step S301, in a case where a user watched an incident and an address of the spot where the incident occurred is in the displayed list, if the user wants to send out additional information to information provision apparatuses 3, the user takes a picture of an appearance of the incident and creates a short sentence about the incident. Thus, the additional information including at least one of (i) the still image or the like representing the appearance of the incident and (ii) a character string is transmitted from information input unit 33d to controller 37d. After that, the user specifies the tag information being displayed by operation input unit 35d and enters a user's intention to provide information with respect to operation input unit 35d.

On the other hand, if the use watched an incident and wants to transmit initial information to information provision apparatuses 3, the user takes a picture of an appearance of the incident or creates a short sentence as described above. Thus, similarly to the above, at least one of (i) the still image or the like and (ii) the character string is transmitted to controller 37d as initial information.

After that, the user enters an intention only to provide information without specifying tag information, in operation input unit 35d.

Next to step S301, controller 37d determines in step S303 of FIG. 3D whether a predetermined waiting time has elapsed since the execution of step S301 or not.

In contrast, if the determination is NO in step S303, controller 37d determines in step S305 of FIG. 3D whether to provide information without specifying tag information or not.

If the determination is YES in step S305, controller 37d sends out the currently held initial information together with a current position acquired from position detector 31d, a current time acquired from a timer (not shown), and the ID of mobile terminal apparatus 3d to communication network 5 via communication unit 39d as shown in step S307 of FIG. 3D.

In contrast to the above, if the determination is NO in step S305, controller 37d determines whether to provide information with specifying the tag information or not in step S309 of FIG. 3D.

If the determination is YES in step S309, controller 37d sends out the specified tag information together with currently held additional information, a current position and the ID of mobile terminal apparatus 3d, and the current time to communication network 5 via communication unit 39d as shown in step S311 of FIG. 3D.

In contrast to the above, if the determination is NO in step S309, controller 37d executes step S303.

Further, if the determination is YES in step S303 or after steps S307, S311 are executed, controller 37d goes back to step S301.

<4-5. About Information Collection Apparatus>

In information collection apparatus 1, as shown in step S401 of FIG. 3E, when information processing unit 13 has received initial information via communication unit 11, information collection unit 13 stores the received initial information in the memory and assigns tag information to the received initial information.

The tag information is constituted by a predetermined symbol to which the address of the incident occurrence point is affixed. The tag information further includes positional information of a reference point. In the case of the initial information, the positional information of the reference point is the positional information, indicating the occurrence point of the incident, included in the initial information.

Next, in step S403 of FIG. 3E, information processing unit 13 sends out the tag information assigned in step S401 together with the positional information of the reference point to communication network 5 via communication unit 11.

As shown in steps S405, S407 of FIG. 3E, after transmitting the tag information, if information processing unit 13 has received additional information via communication unit 11 before a predetermined waiting time elapses, information processing unit 13 stores the received additional information in the memory.

If a determination is YES in step S407, information processing unit 13 chooses in step S409 of FIG. 3E one piece of the additional information received in step S405 and sets the positional information of the information provision apparatus 3 included in the chosen additional information as a positional information of a new reference point. Here, an example of the additional information to be chosen is additional information including the newest transmitting time.

Next, in step S411 of FIG. 3E, information processing unit 13 sends out the tag information including the positional information of the new reference point set in step S409, to communication network 5 via communication unit 11.

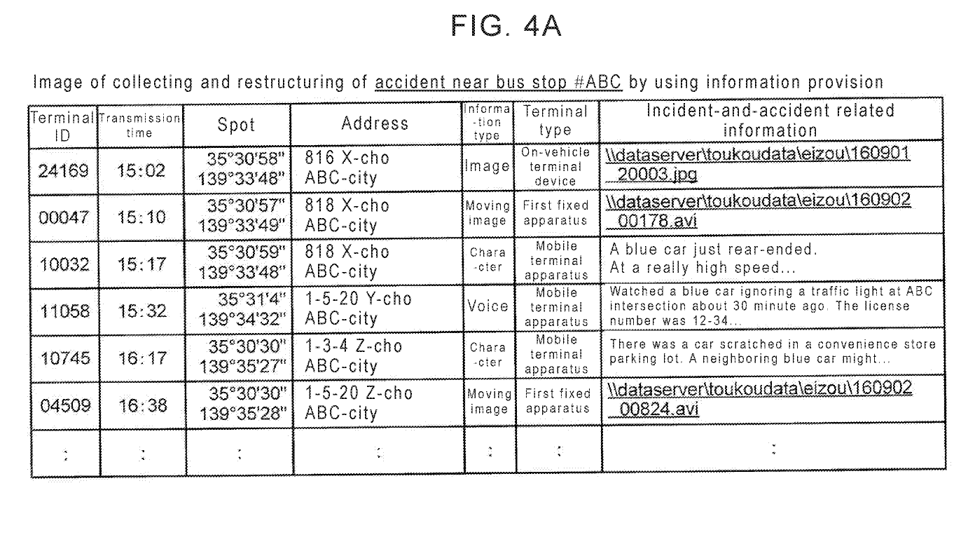

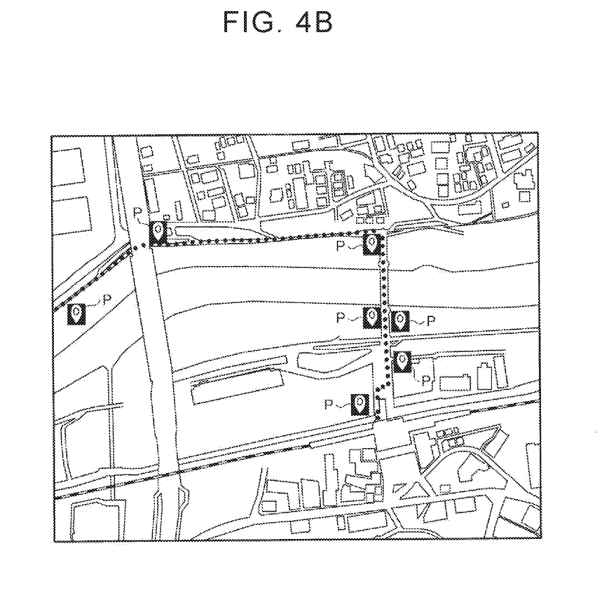

In addition, in next step S413, information processing unit 13 sorts the initial information and the additional information currently stored in the memory in the order of the included transmitting time to generate time series information as shown in FIG. 4A. Specifically, the time series information includes, for example, terminal ID, time information such as transmission time of initial information or additional information, positional information, information type information, terminal type information, incident-and-accident related information, and other information. The positional information is, for example, longitude and latitude information, address information, and other information. The incident-and-accident related information is, for example, image information, movie information, voice information, character information, URL information, and other information. The URL information is information of a URL indicating where image information, movie information, or voice information is. The time series information is information in which the above pieces of information are sorted in the order of transmitting time.

In step S415 of FIG. 3E, information processing unit 13 further generates map information (see FIG. 4B) in which transmission points P included in the initial information and the additional information both currently held in the memory are marked on a previously held map.

After that, information processing unit 13 provides the time series information and the map information respectively generated in steps S413, S415 to investigative organization 7 or the like via communication unit 11.

Next, information processing unit 13 determines in step S417 of FIG. 3E whether a termination condition of collecting information about the object incident is satisfied or not.

Examples of the termination condition include following items (1), (2).

(1) A number of receptions of additional information per unit time is less than or equal to a predetermined threshold number.
(2) A predetermined threshold time has elapsed since initial information was received.

If the determination is YES in step S417, information processing unit 13 finishes the process.

In contrast, if the determination is NO in step S417, information processing unit 13 goes back to step S405 to receive new additional information.

Note that in the above, information processing unit 13 is described to perform the process in the order of steps S409, S411, S413, S415. However, other than the above, information processing unit 13 may perform the process in other orders (for example, the order of steps S413, S415, S409, S411).

### 5. Example of Sequence in Information Collection System

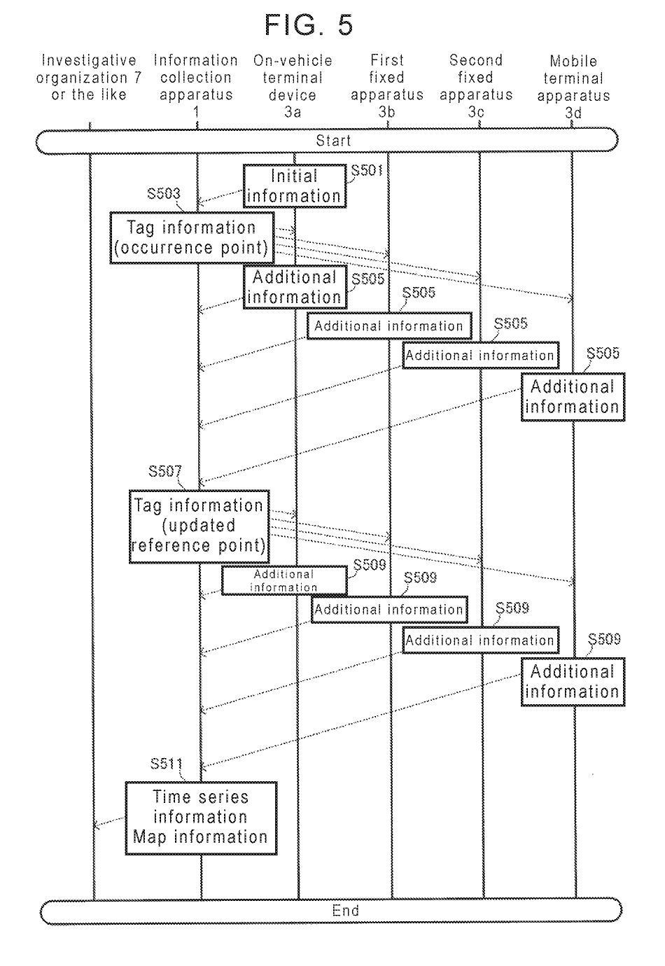

Next, with reference to FIG. 5, an example of a communication sequence in information collection system S will be described.

For example, when vehicle C has caused a rear-end accident (that is, incident) to vehicle B, on-vehicle terminal device 3a in oncoming vehicle A facing vehicles B and C performs the process of FIG. 3A to transmit initial information including a movie and the like to information collection apparatus 1 (sequence S501 of FIG. 5).

Information collection apparatus 1 performs the process of FIG. 3E, and in response to the reception of the initial information, information collection apparatus 1 assigns the tag information including the occurrence point as a reference point to the rear-end accident and sends out the tag information to communication network 5 (sequence S503 of FIG. 5).

Information provision apparatuses 3 (on-vehicle terminal device 3a, first fixed apparatus 3b, second fixed apparatus 3c, and mobile terminal apparatus 3d) in the surrounding area of the occurrence point perform the processes of FIG. 3A to FIG. 3D and transmit additional information including movie and the like to information collection apparatus 1 (sequence S505 of FIG. 5).

Information collection apparatus 1 performs the process of FIG. 3E, and in response to the reception of the additional information, information collection apparatus 1 assigns tag information including a new reference point to the rear-end accident and sends out the tag information to communication network 5 (sequence S507 of FIG. 5).

Information provision apparatuses 3 (on-vehicle terminal device 3a, first fixed apparatus 3b, second fixed apparatus 3c, and mobile terminal apparatus 3d) in the surrounding area of the new reference point perform the processes of FIG. 3A to FIG. 3D and transmit further additional information including movie and the like to information collection apparatus 1 (sequence S509 of FIG. 5).

In information collection system S, sequences S507, S509 are repeated until the termination condition of collecting information is satisfied in information collection apparatus 1.

Then, after the termination condition of collecting information is satisfied, information collection apparatus 1 generates the time series information and the map information as shown in FIG. 4A and FIG. 4B and provides the time series information and the map information to investigative organization 7 or the like (sequence S511 of FIG. 5).

### 6. Action and Effect of Information Collection System

As described above, information collection apparatus 1 can not only acquire initial information informing of an occurrence of an incident from various information provision apparatuses 3 but also acquire additional information by using tag information. Thus, information collection apparatus 1 can collect various pieces of information about the incident.

Further, since the tag information includes an address of an incident occurrence point, the user of each information provision apparatus 3 can identify the incident occurrence point; thus, each user can easily transmit additional information.

Further, every time information collection apparatus 1 transmits tag information, information collection apparatus 1 updates a reference point (an incident occurrence point and a transmission point of additional information) included in each piece of the tag information. Therefore, the transmission point included in each piece of the additional information from the information provision apparatus or apparatuses 3 changes, for example in a case of a hit-and-run incident or the like, depending on a progress of the incident (runaway route of the criminal). Thus, information collection apparatus 1 can acquire more beneficial additional information depending on the progress of the incident.

In addition, since information collection apparatus 1 generates the time series information and the map information shown in FIG. 4A, FIG. 4B based on the collected initial information and additional information, it is possible to generate information more useful for investigative organization 7 or the like.

### 7. Additional Statement

In the above exemplary embodiment, only information provision apparatus or apparatuses 3 in a predetermined area perform the process in step S005 and the following steps based on the reference point included in the tag information, for example, by the process in step S003 of FIG. 3A. However, other than the above, it is also possible that information collection apparatus 1 monitors the positional information of information provision apparatuses 3 in information collection system S so that the tag information is delivered only to information provision apparatus or apparatuses 3 in a predetermined area with respect to the reference point.

In the above exemplary embodiment, steps S413, S415 are executed if the determination is YES in step S407. This flow enables the time series information and the map information to be updated in real time. However, other than the above, steps S413, S415 may be executed after a determination is YES in step S417. In this case, the time series information and the map information are not updated in real time but collectively include the additional information collected during the waiting time.

### INDUSTRIAL APPLICABILITY

An information collection method and an information collection apparatus according to the present disclosure can acquire various pieces of information about an incident and are suitable for a server device and the like on a communication network.

### REFERENCE MARKS IN THE DRAWINGS

1 information collection apparatus
3 information provision apparatus
3a on-vehicle terminal device
3b first fixed apparatus
3c second fixed apparatus
3d mobile terminal apparatus
5 communication network
11 communication unit
11a transmitter
11b receiver
13 information processing unit
31a, 31d position detector
33a, 33b, 33c, 33d information input unit
35a, 35b, 35d operation input unit
37 controller
37a, 37b, 37c, 37d controller
39a, 39b, 39c, 39d communication unit
S information collection system
P transmission point

1. An information collection method in an information collection apparatus that communicates with at least a first information provision apparatus and a second information provision apparatus via a network,
the method comprising:
transmitting, when the information collection apparatus has received first positional information associated with an incident from the first information provision apparatus, second positional information corresponding to the first positional information to at least the second information provision apparatus; and
receiving by the information collection apparatus third positional information associated with the incident from the second information provision apparatus having received the second positional information.

2. The information collection method according to claim 1, wherein at least the second positional information includes address information corresponding to the first positional information.

3. The information collection method according to claim 1, wherein the second positional information defines an area that includes a spot of the first positional information and is wider than the spot of the first positional information.

4. The information collection method according to claim 1, wherein the information collection apparatus further communicates with a third information provision apparatus via the network,
the method further comprising transmitting, when the information collection apparatus has received fourth positional information associated with the incident from the second information provision apparatus, fifth positional information corresponding to the fourth positional information to at least the third information provision apparatus.

5. The information collection method according to claim 1, further comprising:
transmitting, when the information collection apparatus has received from the first information provision apparatus first time information together with the first positional information associated with the incident, the second positional information corresponding to the first positional information to at least the second information provision apparatus; and
receiving by the information collection apparatus second time information together with the third positional information associated with the incident, from the second information provision apparatus having received the second positional information.

6. The information collection method according to claim 1, further comprising generating, when the information collection apparatus has received the first positional information and the third positional information, map information representing the first positional information and the third positional information.

7. An information collection method in an information collection apparatus that communicates with at least a first information provision apparatus and a second information provision apparatus via a network, the method comprising:
transmitting, when the information collection apparatus has received first information associated with an incident from the first information provision apparatus, second information corresponding to the first information to at least the second information provision apparatus; and
receiving by the information collection apparatus third information associated with the incident from the second information provision apparatus having received the second information.

8. The information collection method according to claim 7, wherein each of the first information, the second information, and the third information includes at least one of following pieces of information (1) to (7):
(1) time information;
(2) positional information;
(3) image information;
(4) movie information;
(5) voice information;
(6) character information; and
(7) URL information.

9. An information collection apparatus that communicates with at least a first information provision apparatus and a second information provision apparatus via a network,
wherein
when the information collection apparatus has received first positional information associated with an incident from the first information provision apparatus, the information collection apparatus transmits second positional information corresponding to the first positional information to at least the second information provision apparatus, and
the information collection apparatus receives third positional information associated with the incident from the second information provision apparatus having received the second positional information.

10. The information collection apparatus according to claim 9, wherein at least the second positional information includes address information corresponding to the first positional information.

11. The information collection apparatus according to claim 9, wherein the second positional information defines an area that includes a spot of the first positional information and is wider than the spot of the first positional information.

12. The information collection apparatus according to claim 9, wherein
the information collection apparatus further communicates with a third information provision apparatus via the network, and
when the information collection apparatus has received fourth positional information associated with the incident from the second information provision apparatus, the information collection apparatus transmits fifth positional information corresponding to the fourth positional information to at least the third information provision apparatus.

13. The information collection apparatus according to claim 9, wherein
when the information collection apparatus has received from the first information provision apparatus first time information together with the first positional information associated with the incident, the information collection apparatus transmits the second positional information corresponding to the first positional information to at least the second information provision apparatus, and
the information collection apparatus receives second time information together with the third positional information associated with the incident, from the second information provision apparatus having received the second positional information.

14. The information collection apparatus according to claim 9, wherein when the information collection apparatus has received the first positional information and the third positional information, the information collection apparatus generates map information representing the first positional information and the third positional information.

15. An information collection apparatus that communicates with at least a first information provision apparatus and a second information provision apparatus via a network, wherein
when the information collection apparatus has received first information associated with an incident from the first information provision apparatus, the information collection apparatus transmits second information corresponding to the first information to at least the second information provision apparatus, and
the information collection apparatus receives third information associated with the incident from the second information provision apparatus having received the second information.

16. The information collection apparatus according to claim 15, wherein each of the first information, the second information, and the third information includes at least one of following pieces of information (1) to (7):
(1) time information;
(2) positional information;
(3) image information;
(4) movie information;
(5) voice information;
(6) character information; and
(7) URL information.
